(19) United States
(12) Patent Application Publication
(10) Pub. No.: US 2014/0071322 A1
(43) Pub. Date: Mar. 13, 2014

(54) IMAGE PICKUP APPARATUS WITH IMAGE PICKUP DEVICE AND CONTROL METHOD FOR IMAGE PICKUP APPARATUS

(71) Applicant: CANON KABUSHIKI KAISHA, Tokyo (JP)

(72) Inventor: Koichi Fukuda, Tokyo (JP)

(73) Assignee: CANON KABUSHIKI KAISHA, Tokyo (JP)

(21) Appl. No.: 14/017,993

(22) Filed: Sep. 4, 2013

(30) Foreign Application Priority Data
Sep. 11, 2012 (JP) 2012-199363

(51) Int. Cl. H04N 5/232

(52) U.S. Cl. CPC H04N 5/23212
USPC 348/332

(57) ABSTRACT

An image pickup apparatus capable of making focus detection performance and image pickup performance compatible with each other. A plurality of image pickup pixels detect a subject image formed by an imaging optical system and generate an image for image pickup. Microlenses disposed for the respective image pickup pixels gather incident light to the respective image pickup pixels. Each image pickup pixel has a plurality of photoelectric converters divided in a first direction and a second direction perpendicular to the first direction. Each photoelectric converter photoelectrically converts each of subject images having passed through pupil partial areas corresponding to the respective photoelectric converters in an exit pupil of the imaging optical system and outputs focus detection signals for detecting a phase difference between the subject images. A first curvature of the microlenses in the first direction and a second curvature of the microlenses in the second direction are different.

### BACKGROUND OF THE INVENTION

1. Field of the Invention

The present invention relates to an image pickup apparatus with an image pickup device such as an image sensor, and a control method for the image pickup apparatus.

2. Description of the Related Art

As one of methods to detect a focus state of a taking lens in an image pickup apparatus such as a digital camera, there is generally known a pupil-dividing phase difference method using a two-dimensional image pickup device in which microlenses are provided for respective pixels (light-incident surface phase difference method).

For example, according to U.S. Pat. No. 4,410,804, a focus state of a taking lens is detected by a light-incident surface phase difference method using a two-dimensional image pickup device in which, for one pixel, one microlens is provided, and a plurality of photoelectric converters is formed. Here, the plurality of photoelectric converters receives light in different areas of an exit pupil of a taking lens via one microlens. Focus detection is carried out using the light-incident surface phase difference method by obtaining the amount of image shift based on output signals from the plurality of photoelectric converters.

Further, according to U.S. Pat. No. No. 4,410,804, output signals from the plurality of photoelectric converters are summed to obtain an image pickup signal (image signal). Moreover, disparity signals obtained by left-side and right-side photoelectric converters in each of pixels are separately displayed for the right eye and the left eye, respectively, as a stereoscopic image on a display.

On the other hand, according to Japanese Laid-Open Patent Publication (Kokai) No. 2000-156823, a two-dimensional image pickup device has a plurality of image pickup pixels and a pair of partially-disposed focus detection pixels, and the pair of focus detection pixels receives light in different areas of an exit pupil of a taking lens through a light-shielding layer having an opening. According to Japanese Laid-Open Patent Publication (Kokai) No. 2000-156823, focus detection is carried out by obtaining the amount of image shift based on output signals from the image pickup pixels and output signals (focus detection signals) from the focus detection pixels.

As described above, in the image pickup devices described in U.S. Pat. No. 4,410,804 and Japanese Laid-Open Patent Publication (Kokai) No. 2000-156823, a focus detection signal for focus detection using the light-incident surface phase difference method and an image pickup signal for generating a photographic image are obtained by one image pickup device.

However, there is a problem that when a focus state of a taking lens is to be detected with accuracy using the light-incident surface phase difference method as described above, that is, when focus detection performance is to be improved, degradation in image pickup performance for obtaining images will inevitably occur.

Namely, according to the light-incident surface phase difference method, the curvature of a microlens with good focus detection performance and the curvature of a microlens with good image pickup performance are not always the same, and it is thus difficult to make focus detection performance and image pickup performance compatible with each other.

### SUMMARY OF THE INVENTION

The present invention provides an image pickup apparatus which is capable of making focus detection performance and image pickup performance compatible with each other, and a control method for the image pickup apparatus.

Accordingly, a first aspect of the present invention provides an image pickup apparatus comprising an imaging optical system, a plurality of image pickup pixels configured to detect a subject image formed by the imaging optical system and generate an image for image pickup, and lenses configured to be disposed for respective ones of the plurality of image pickup pixels and gather incident light to the respective ones of the plurality of image pickup pixels, wherein each of the plurality of image pickup pixels comprises a plurality of photoelectric converters that are divided in a first direction and a second direction perpendicular to the first direction, each of the plurality of photoelectric converters photoelectrically converts each of a plurality of subject images having passed through pupil partial areas corresponding to respective ones of the plurality of photoelectric converters in an exit pupil of the imaging optical system and outputs focus detection signals for use in detecting a phase difference between the plurality of subject images, and a first curvature of the lenses in the first direction and a second curvature of the lenses in the second direction are different.

Accordingly, a second aspect of the present invention provides an image pickup apparatus comprising an imaging optical system, a plurality of image pickup pixels configured to detect a subject image formed by the imaging optical system and generate an image for image pickup, and lenses configured to be disposed for respective ones of the plurality of image pickup pixels and gather incident light to the respective ones of the plurality of image pickup pixels, wherein each of the plurality of image pickup pixels comprises a plurality of photoelectric converters that are divided in a first direction and a second direction perpendicular to the first direction, each of the plurality of photoelectric converters photoelectrically converts each of a plurality of subject images having passed through pupil partial areas corresponding to respective ones of the plurality of photoelectric converters in an exit pupil of the imaging optical system and outputs focus detection signals for use in detecting a phase difference between the plurality of subject images, and a focal position of the lenses in the first direction and a focal position of the lenses in the second direction are different.

Accordingly, a third aspect of the present invention provides an image pickup apparatus comprising an imaging optical system, a plurality of image pickup pixels configured to detect a subject image formed by the imaging optical system and generate an image for image pickup, and lenses configured to be disposed for respective ones of the plurality of image pickup pixels and gather incident light to the respective ones of the plurality of image pickup pixels, wherein each of the plurality of image pickup pixels comprises a plurality of photoelectric converters that are divided in a first direction and a second direction perpendicular to the first direction, each of the plurality of photoelectric converters photoelectrically converts each of a plurality of subject images having passed through pupil partial areas corresponding to respective ones of the plurality of photoelectric converters in an exit pupil of the imaging optical system and outputs focus detection signals for use in detecting a phase difference between the plurality of subject images, and a first curvature of the lenses in the first direction is greater than a second curvature of the lenses in the second direction.

Accordingly, a fourth aspect of the present invention provides an image pickup apparatus comprising an imaging optical system, a plurality of image pickup pixels configured to detect a subject image formed by the imaging optical system and generate an image for image pickup, and lenses configured to be disposed for respective ones of the plurality of image pickup pixels and gather incident light to the respective ones of the plurality of image pickup pixels, wherein each of the plurality of image pickup pixels comprises a plurality of photoelectric converters that are divided in a first direction and a second direction perpendicular to the first direction, each of the plurality of photoelectric converters photoelectrically converts each of a plurality of subject images having passed through pupil partial areas corresponding to respective ones of the plurality of photoelectric converters in an exit pupil of the imaging optical system and outputs focus detection signals for use in detecting a phase difference between the plurality of subject images, and a focal position of the lenses in the first direction lies on a subject side relative to light-receiving surfaces of the plurality of photoelectric converters, and a focal position of the lenses in the second direction lies on the light-receiving surfaces of the plurality of photoelectric converters.

Accordingly, a fifth aspect of the present invention provides a control method for an image pickup apparatus which has an imaging optical system, a plurality of image pickup pixels that detect a subject image formed by the imaging optical system and generate an image for image pickup, each of the plurality of image pickup pixels having a plurality of photoelectric converters divided in a first direction and a second direction perpendicular to the first direction, and lenses that are disposed for respective ones of the plurality of image pickup pixels and gather incident light to the respective ones of the plurality of image pickup pixels, comprising a setting step of making a first curvature of the lenses in the first direction and a second curvature of the lenses in the second direction different from each other, a photoelectrical conversion step of photoelectrically converting a plurality of subject images having passed through pupil partial areas corresponding to respective ones of the plurality of photoelectric converters in an exit pupil of the imaging optical system, an output step of outputting focus detection signals based on the plurality of subject images that have been photoelectrically converted, and a phase difference detection step of detecting a phase difference between the plurality of subject images based on the output focus detection signals.

According to the present invention, high focus detection performance and high image pickup performance in the light-incident surface phase difference method can be compatible with each other.

Further features of the present invention will become apparent from the following description of exemplary embodiments (with reference to the attached drawings).

### BRIEF DESCRIPTION OF THE DRAWINGS

FIG. 1 is a block diagram schematically showing an image pickup apparatus having an image pickup device according to an embodiment of the present invention.

FIG. 2 is a view useful in explaining an exemplary pixel array in the image pickup device appearing in FIG. 1.

FIGS. 3A to 3D are views useful in explaining one pixel appearing in FIG. 2, in which FIG. 3A is a plan view of one pixel as viewed from a light receiving surface side (+z side) of the image pickup device, FIG. 3B is a cross-sectional view taken along line a-a of FIG. 3A as viewed from a −y side, FIG. 3C is a cross-sectional view taken along line b-b of FIG. 3A as viewed from a +x side, and FIG. 3D is a contour line diagram of a microlens provided in one pixel as viewed from the light receiving surface side (+z side) of the image pickup device.

FIG. 4 is a view useful in explaining the correspondence between the structure of the pixel appearing in FIGS. 3A to 3D and pupil-dividing.

FIGS. 5A to 5C are views useful in explaining how a microlens gathers light inside one pixel appearing in FIGS. 3A to 3D, in which FIG. 5A shows how the microlens gathers light in the cross section appearing in FIG. 3B, FIG. 5B shows how the microlens gathers light in the cross section appearing in FIG. 3C, and FIG. 5C is a view showing a light-gathering spot of the microlens on the light receiving surfaces of the photoelectric converter.

FIGS. 6A to 6C are views useful in explaining the relationship among pupil partial areas of sub pixels and an exit pupil of an imaging optical system at a peripheral image height of the image pickup device appearing in FIG. 2, in which FIG. 6A is a view useful in explaining the relationship between an exit pupil distance of the imaging optical system and a setting pupil distance of the image pickup device when they are the same, FIG. 6B is a view useful in explaining the relationship between the exit pupil distance of the imaging optical system and the setting pupil distance of the image pickup device when the exit pupil distance of the imaging optical system is shorter than the setting pupil distance of the image pickup device, and FIG. 6C is a view useful in explaining the relationship between the exit pupil distance of the imaging optical system and the setting pupil distance of the image pickup device when the exit pupil distance of the imaging optical system is longer than the setting pupil distance of the image pickup device.

FIG. 7 is a view showing exemplary pupil intensity distributions of the image pickup device according to the present embodiment and comparative examples.

FIG. 8 is a view showing other exemplary pupil intensity distributions of the image pickup device according to the present embodiment and the comparative examples.

### DESCRIPTION OF THE EMBODIMENTS

The present invention will now be described in detail with reference to the drawings showing an embodiment thereof.

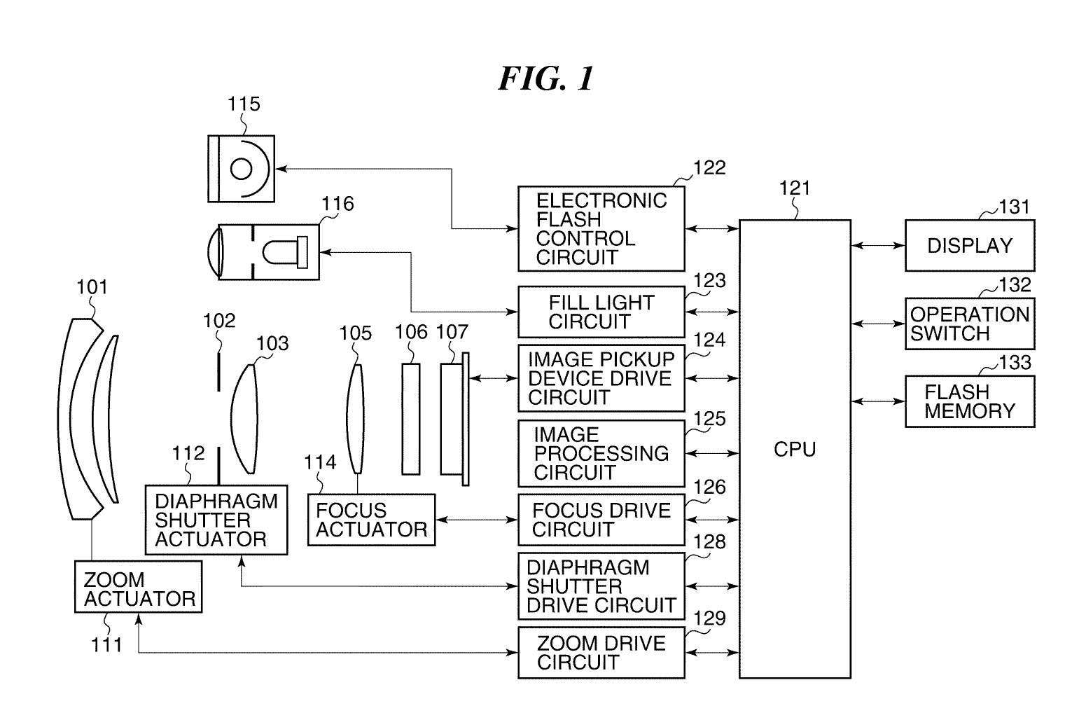

FIG. 1 is a block diagram schematically showing an arrangement of an exemplary image pickup apparatus having an image pickup device according to an embodiment of the present invention.

The image pickup apparatus shown in the figure is, for example, a digital camera, and has a first lens group 101 at an end of an imaging optical system. The first lens group 101 is movable forward and backward in a direction of an optical axis. A diaphragm shutter 102 disposed on a rear side of the first lens group 101, and the diaphragm shutter 102 adjusts the amount of light during shooting by adjusting its aperture, and is further used as an exposure second adjusting shutter during taking of still images.

A second lens group 103 is disposed on a rear side of the diaphragm shutter 102. The diaphragm shutter 102 and the second lens group 103 integrally move backward and backward in the direction of the optical axis to exert a magnification changing action (zooming function) in response to forward and backward movement of the first lens group 101.

A third lens group 105 is capable of moving forward and backward in the direction of the optical axis, and the third lens group adjusts focus through this forward and backward movement. An optical low pass filter 106, which is disposed on a rear side of the third lens group 105, is an optical device for reducing false color and moiré of a photographic image. On a rear side of the optical low pass filter 106, an image pickup device 107 which is comprised of a two-dimensional CMOS photo-sensor and its peripheral circuits is disposed on a light-incident surface of the imaging optical system. An optical image is formed on the image pickup device 107, which in turn outputs an image signal corresponding to the optical image.

When a cam cylinder, not shown, is rotated, a zoom actuator 111 causes the first lens group 101 and the second lens group 103 to move forward and backward in the direction of the optical axis and perform zooming. A diaphragm shutter actuator 112 adjusts the amount of light in shooting by controlling the aperture of the diaphragm shutter 102, and also controls exposure time during taking of still images. A focus actuator 114 adjusts focus by moving the third lens group 105 forward and backward in the direction of the optical axis.

An illumination electronic flash 115 illuminates a subject as the need arises during shooting. It is preferred that a flash light illumination device using a xenon tube is used as the illumination electronic flash 115, but an illumination device having an LED capable of continuously emitting light may be used. An AF fill light unit 116 throws an image of a mask having a predetermined opening pattern onto a subject via a projector lens. This improves focus detection performance for a dark subject or a low-contrast subject.

A CPU 121, which is responsible for controlling the entire camera, has an computation unit, a ROM, a RAM, an A/D converter, a D/A converter, a communication interface circuit, and so on, although they are not shown. The CPU 121 causes the camera to execute sequential operations comprised of, for example, AF, shooting, image processing, and recording by controlling the camera based on predetermined programs stored in the ROM.

An electronic flash control circuit 122 controls turning-on and off of the illumination electronic flash 115 in synchronization with a shooting operation under the control of the CPU 121. A fill light drive circuit 123 controls turning-on and off of the AF fill light unit 116 in synchronization with a focus detecting operation under the control of the CPU 121. An image pickup device drive circuit 124 controls an image taking operation of the image pickup device 107 under the control of the CPU 121 and also subjects an image signal obtained from the image pickup device 107 to A/D conversion and sends the resulting image signal to the CPU 121. An image processing circuit 121 subjects an image signal, which is obtained from the image pickup device 107, to image processing such as γ conversion, color interpolation, and JPEG compression under the control of the CPU 121.

A focus drive circuit 126 drivingly controls the focus actuator 114 based on a focus detection result, to be described later, under the control of the CPU 121, causing the third lens group 105 to move forward and backward in the direction of the optical axis and adjust focus. A diaphragm shutter drive circuit 128 drivingly controls the diaphragm shutter actuator 112 under the control of the CPU 121, thus controlling the aperture of the diaphragm shutter 102. A zoom drive circuit 129 drives the zoom actuator 111 in response to a zooming operation by a user under the control of the CPU 121.

A display 131 is, for example, an LCD, and the CPU 121 displays, on the display 131, information on a shooting mode of the camera, a preview image before shooting, a review image after shooting, a display image which represents a focusing state during focus detection, and so on. An operation switch group 132 includes a power-supply switch, a release (shooting trigger) switch, a zooming operation switch, and a shooting mode selection switch, and the user gives various instructions to the CPU 121 by operating the operation switch group 132. A flash memory 133 is able to be attached to and removed from the camera, and the CPU 121 records, in the flash memory 133, images that have already been taken (image data).

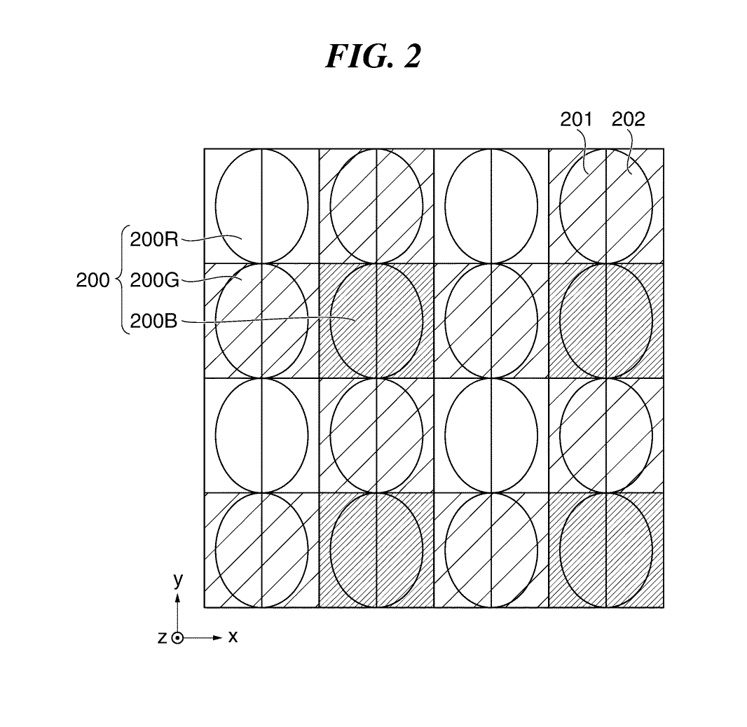

FIG. 2 is a view useful in explaining an exemplary pixel array in the image pickup device 107 appearing in FIG. 1.

The image pickup device 107 appearing in FIG. 2 has a plurality of pixels arrayed in a two-dimensional matrix. Here, a pixel array with four rows and four columns, and a sub pixel array with eight rows and four columns in the two-dimensional CMOS sensor (image pickup device) are shown. A number of pixel groups with four rows and four columns shown in FIG. 2 are disposed on an image pickup device surface, and the image pickup device 107 outputs an image signal corresponding to an optical image. It should be noted that as described above, in the example shown in the figure, each pixel is comprised of two sub pixels.

Here, the image pickup device 107 has a pixel cycle of 4 μm, 5575 horizontal rows×3725 vertical columns=about 20 million effective pixels, and a light-incident screen that is 22.3 mm wide and 14.9 mm long.

Referring to FIG. 2, in a pixel group 200 with two rows and two columns, a pixel 200R having a spectral sensitivity of R (red) is disposed at the upper left, and pixels 200G having a spectral sensitivity of G (green) are disposed at the upper right and the lower left. A pixel 200B having a spectral sensitivity of B (blue) is disposed at the lower right. Further, N1×N2 (1×2) sub pixels 201 and sub pixels 202 are two-dimensionally arranged in each pixel, where N1 is a first division number in a first direction (y-direction) and N2 is a second division number in a second direction (x-direction).

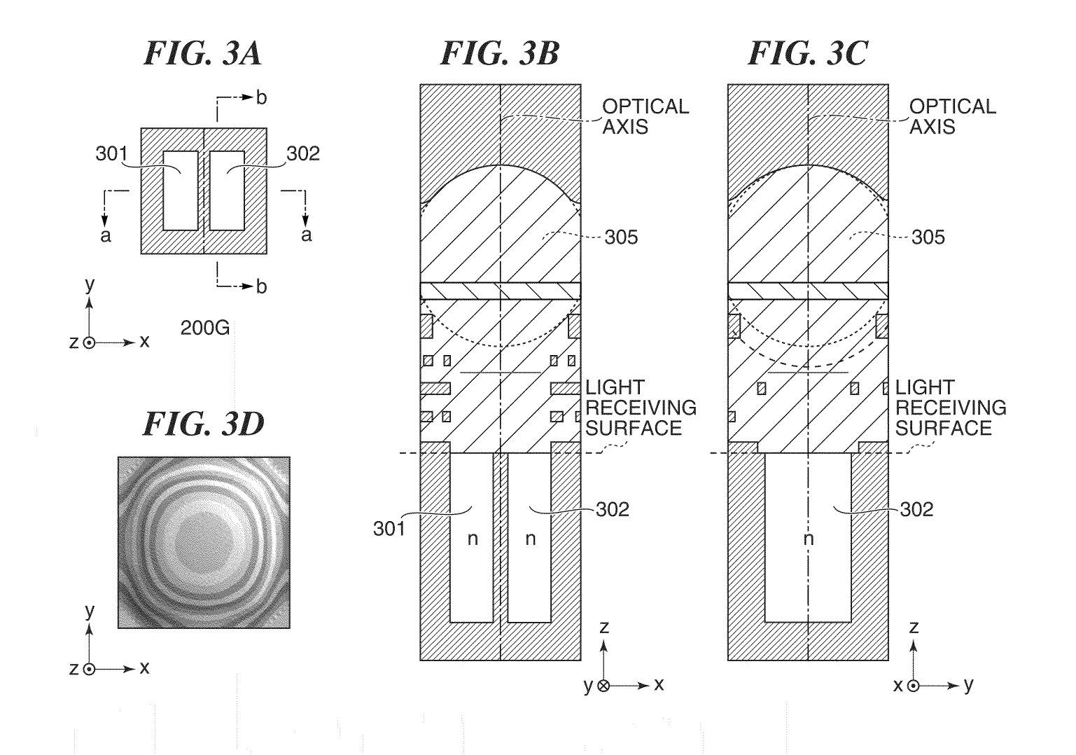

FIGS. 3A to 3D are views useful in explaining one pixel 200G appearing in FIG. 2. FIG. 3A is a plan view of one pixel 200G as viewed from a light receiving surface side (+z side) of the image pickup device, and FIG. 3B is a cross-sectional view taken along line a-a of FIG. 3A as viewed from a −y side. FIG. 3C is a cross-sectional view taken along line b-b of FIG. 3A as viewed from a +x side, and FIG. 3D is a contour line diagram of a microlens provided in one pixel 200G as viewed from the light receiving surface side (+z side) of the image pickup device.

Referring to FIGS. 3A to 3C, the pixel 200G is divided in the first direction (y-direction) by the first division number (here, N1=1) (N1=1 means no division) and divided in the second direction (x-direction), which is perpendicular to the first direction, by the second division number (here, N2=1) to form N1×N2 (1×2) photoelectric converters consisting of a photoelectric converter 301 and a photoelectric converter 302. It should be noted that the photoelectric converter 301 and the photoelectric converter 302 correspond to the sub pixel 201 and the sub pixel 202 appearing in FIG. 2. Here, the other pixels are also divided in the same manner.

Further, referring to FIGS. 3B to 3D, a microlens 305 for gathering incident light is disposed in the pixel 200G. A first curvature of microlens 305 in the first direction (y-direction) in which the division number relating to photoelectric converters is smaller (the first division number N1=1) than a second curvature of the microlens 305 in the second direction (x-direction) in which the division number relating to photoelectric converters is greater (the second division number N2=2). It should be noted that here, microlenses are disposed in respective other pixels as well, and the second curvature of these microlenses is greater than the first curvature.

In the image pickup device 107 shown in the figure, each pixel has a microlens and N1×N2 photoelectric converters divided by the first division number N1 in the first direction and the second division number N2 in the second direction. The second division number N2 is equal to or greater than the first division number N1 (equal to or greater than the first division number), and the second curvature of the microlens in the second direction is greater than the first curvature of the microlens in the first direction.

In the example shown in the figure, p-i-n structure photodiodes having an intrinsic layer interposed between a p-type layer and an n-type layer may be used as the photoelectric converter 301 and the photoelectric converter 302, and as the need arises, p-n junction photodiodes may be used with an intrinsic layer omitted.

In each pixel, color filters (not shown) are disposed between the microlens 305 and the photoelectric converter 301 and the photoelectric converter 302. Moreover, as the need arises, the spectral transmittance of color filters may be varied with sub pixels, and further, color filters may be dispensed with.

Light incident on the pixel 200G appearing in FIGS. 3A to 3D is gathered by the microlens 305, dispersed by the color filter, and then received by the photoelectric converter 301 and the photoelectric converter 302.

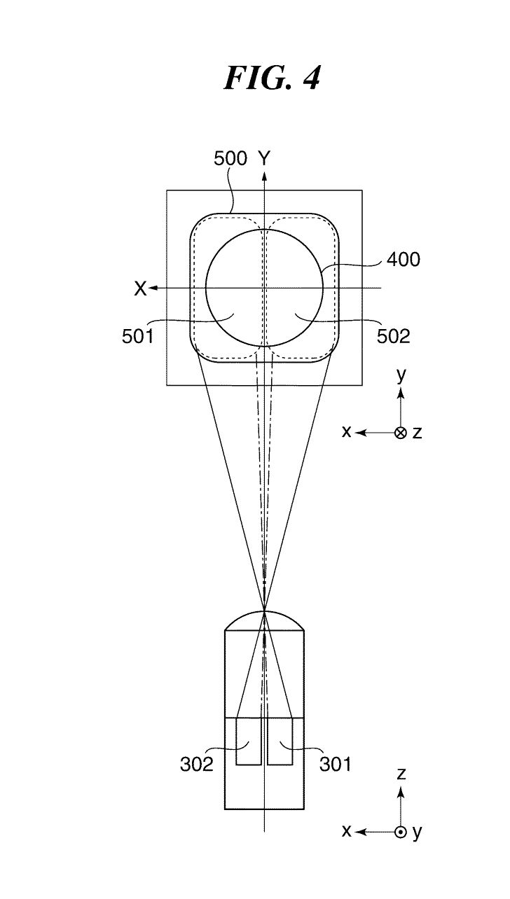

FIG. 4 is a view useful in explaining the correspondence between the structure of the pixel appearing in FIGS. 3A to 3D and pupil-dividing.

In FIG. 4, there is shown an exit pupil surface in the imaging optical system when an a-a cross-section of the pixel appearing in FIG. 3A is viewed from the +y side, and for coincidence with coordinate axes of the exit pupil surface, the x-axis and the y-axis in FIG. 3A are inverted.

The image pickup device 107 is disposed close to an image forming surface of a taking lens (that is, the imaging optical system), and light bundles from a subject pass through an exit pupil 400 of the imaging optical system to enter each pixel. A pupil partial area 501 and a pupil partial area 502 have a substantially conjugating relationship with light receiving surfaces of the photoelectric converter 301 and the photoelectric converter 302 (that is, the sub pixels 201 and 202), which are divided into N1×N2 (1×2) due to the microlens 305, and represent pupil partial areas capable of receiving light for respective photoelectric converters (sub pixels).

A pupil area 500 is able to receive light over the entire pixel 200G when the photoelectric converter 301 and the photoelectric converter 302 divided into N1×N2 (1×2) are combined together.

The diameter of the microlens 305 is several micrometers, whereas a pupil distance is generally several tens of millimeters. Thus, an aperture value of the microlens 305 is tens of thousands, and blurring due to a diffraction of several tens of millimeters occurs. For this reason, images on light receiving surfaces of the photoelectric converter 301 and the photoelectric converter 302 are not clear pupil areas or pupil partial areas but are pupil intensity distributions (incident angle distributions on the light receiving surfaces).

Referring to FIG. 4, due to the microlens 305, the pupil partial area 501 of the sub pixel 201 (first focal detection pixel) has a substantially conjugating relationship with the light receiving surface of the photoelectric converter 301 whose center of gravity is eccentric in the −x direction, and represents a pupil area capable of receiving light over the sub pixel 201. The pupil partial area 501 of the sub pixel 201 has its center of gravity eccentric on the +X side on a pupil surface.

Referring to FIG. 4, due to the microlens 305, the pupil partial area 502 of the sub pixel 202 (second focal detection pixel) has a substantially conjugating relationship with the light receiving surface of the photoelectric converter 302 whose center of gravity is eccentric in the +x direction, and represents a pupil area capable of receiving light over the sub pixel 202. The pupil partial area 502 of the sub pixel 202 has its center of gravity eccentric on the −X side on a pupil surface.

Here, it is assumed that a signal obtained from the sub pixel 201 constituting the pixel 200G (200R or 200B) disposed in the image pickup device 107 is an A image. Likewise, it is assumed that a signal obtained from the sub pixel 202 constituting the pixel 200G (200R or 200B) disposed in the image pickup device 107 is a B image. Focus detection can be performed using a light-incident surface phase difference method by calculating the amount of image shift (relative positions) between the A image and the B image and converting the calculated amount into the amount of defocus (out-of-focus amount).

On the other hand, the pupil area 500 of the pixel 200G (image pickup pixel) which is a combination of the sub pixel 201 and the sub pixel 202 is configured to be as large as possible so as to receive a large amount of light bundles having passed through the exit pupil 400 of the imaging optical system. Moreover, the center of gravity of the pupil area 500 is determined so as to be substantially coincident with an optical axis of the imaging optical system at a predetermined pupil distance.

By summing a pixel signal obtained from the sub pixel 201 and a pixel signal obtained from the sub pixel 202 with respect to each of the pixels 200G (200R or 200B) arranged in the image pickup device 107, a photographic image at a resolution corresponding to the number of effective pixels can be generated.

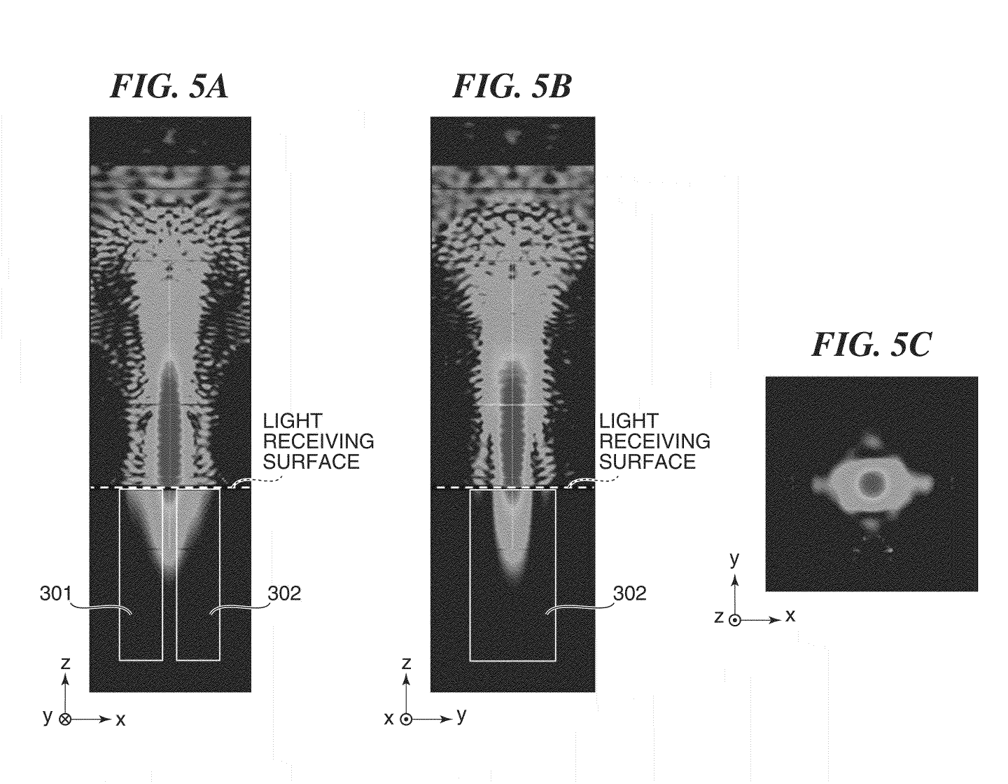

FIGS. 5A to 5C are views useful in explaining how the microlens 305 gathers light inside one pixel 200G appearing in FIGS. 3A to 3D. FIG. 5A shows how the microlens 305 gathers light in the cross section appearing in FIG. 3B, and FIG. 5B shows how the microlens 305 gathers light in the cross section appearing in FIG. 3C. FIG. 5C is a view showing a light-gathering spot of the microlens 305 on the light receiving surfaces of the photoelectric converters.

Because the curvature of the microlens 305 is greater in the second direction (x-direction) in which the division number is greater (the second division number N2=2) (the second curvature>the first curvature) as described earlier, the focal point of the microlens 305 lies on a front focus side (on the light receiving side, that is, the front side) relative to the light receiving surfaces of the photoelectric converters. On the other hand, in the first direction (y-direction) in which the division number is smaller (the first division number N1=1), the curvature of the microlens 305 is small, and hence as shown in FIG. 5B, the focal point of the microlens 305 lies close to the light receiving surfaces of the photoelectric converters.

Thus, as shown in FIG. 5C, the light-gathering spot of the microlens 305 on the light receiving surfaces of the photoelectric converters is long in the second direction (x-direction) in which the division number is greater (the second division number N2=2) and short in the first direction (y-direction) in which the division number is smaller (the first division number N1=1).

Here, a description will be given of pupil shift in the image pickup device 107 described above.

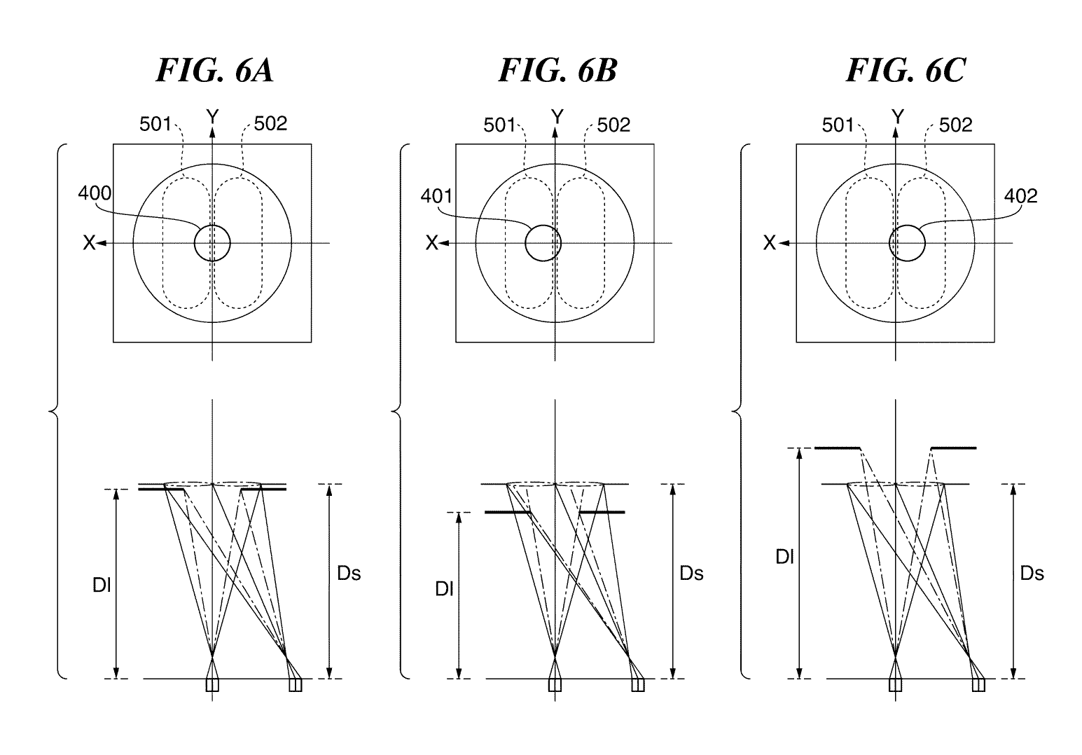

FIGS. 6A to 6C are views useful in explaining the relationship among the pupil partial area 501 of the sub pixel 201, the pupil partial area 502 of the sub pixel 202, and the exit pupil of the imaging optical system at a peripheral image height of the image pickup device shown in FIG. 2. FIG. 6A is a view useful in explaining the relationship between an exit pupil distance Dl of the imaging optical system and a setting pupil distance Ds of the image pickup device when they are the same, and FIG. 6B is a view useful in explaining the relationship between the exit pupil distance Dl of the imaging optical system and the setting pupil distance Ds of the image pickup device when the exit pupil distance Dl of the imaging optical system is shorter than the setting pupil distance Ds of the image pickup device. FIG. 6C is a view useful in explaining the relationship between the exit pupil distance Dl of the imaging optical system and the setting pupil distance Ds of the image pickup device when the exit pupil distance Dl of the imaging optical system is longer than the setting pupil distance Ds of the image pickup device.

In FIG. 6A, the pupil partial area 501 of the sub pixel 201 and the pupil partial area 502 of the sub pixel 202 almost evenly pupil-divides the exit pupil 400 of the imaging optical system. On the other hand, referring to FIG. 6B, at a peripheral image height of the image pickup device, pupil shift between the exit pupil of the imaging optical system and the entrance pupil of the imaging optical system occurs, causing the exit pupil 401 of the imaging optical system to be unevenly pupil-divided.

Likewise, in FIG. 6C as well, at a peripheral image height of the image pickup device, pupil shift between the exit pupil of the imaging optical system and the entrance pupil of the imaging optical system occurs, causing the exit pupil 402 of the imaging optical system to be unevenly pupil-divided.

With the uneven pupil-dividing, the intensities of the A image and the B image also become uneven; the intensity of one of the A image and the B image increases, and the intensity of the other one decreases. For this reason, when the intensities of the A image and the B image are uneven to a large extent at a peripheral image height or the like, a signal associated with one of the A image and the B image cannot be obtained with sufficient intensity, resulting in degradation in focus detection performance.

A description will now be given of compatibility between focus detection performance and image pickup performance.

As described earlier, because in the image pickup device 107 according to the present embodiment, the curvature of the microlens 305 is greater in the second direction (x-direction) in which the division number is greater according to the photoelectric converters (the second division number N2=2) (the second curvature>the first curvature), the focal point of the microlens 305 lies on a front focus side (on the light receiving side) relative to the light receiving surfaces of the photoelectric converters.

Moreover, because the curvature of the microlens 305 in the first direction (y-direction) in which the division number is smaller (the first division number N1=1), the focal point of the microlens 305 lies close to the light receiving surfaces of the photoelectric converters.

Here, for comparison with the image pickup device 107 according to the present embodiment, an image pickup device in which the curvature of the microlens 305 is the first curvature (<the second curvature) in both the second direction (x-direction) and the first direction (y-direction) in each of pixels is taken up as a comparative example 1. It should be noted that other features of the comparative example 1 are the same as those of the image pickup device 107 according to the present embodiment.

In the comparative example 1, in order to increase image pickup sensitivity by improving the light receiving efficiency of the pixel 200, the focal point of the microlens is positioned close to the light receiving surfaces of the photoelectric converters, and thus image pickup sensitivity associated with image pickup performance is given a higher priority.

Further, an image pickup device in which the curvature of the microlens 305 is the second curvature (>the first curvature) in both the second direction (x-direction) and the first direction (y-direction) in each of pixels is taken up as a comparative example 2. It should be noted that other features of the comparative example 2 are the same as those of the image pickup device 107 according to the present embodiment.

In the comparative example 2, in order to reduce unevenness in intensity between the A image and the B image by making pupil-dividing loose in response to pupil shift at a peripheral image height, the focal point of the microlens is shifted to a front focus side (the light receiving side) relative to the light receiving surfaces of the photoelectric converters, so that the capability to respond to pupil shift, which is associated with focal detection performance, is given a higher priority.

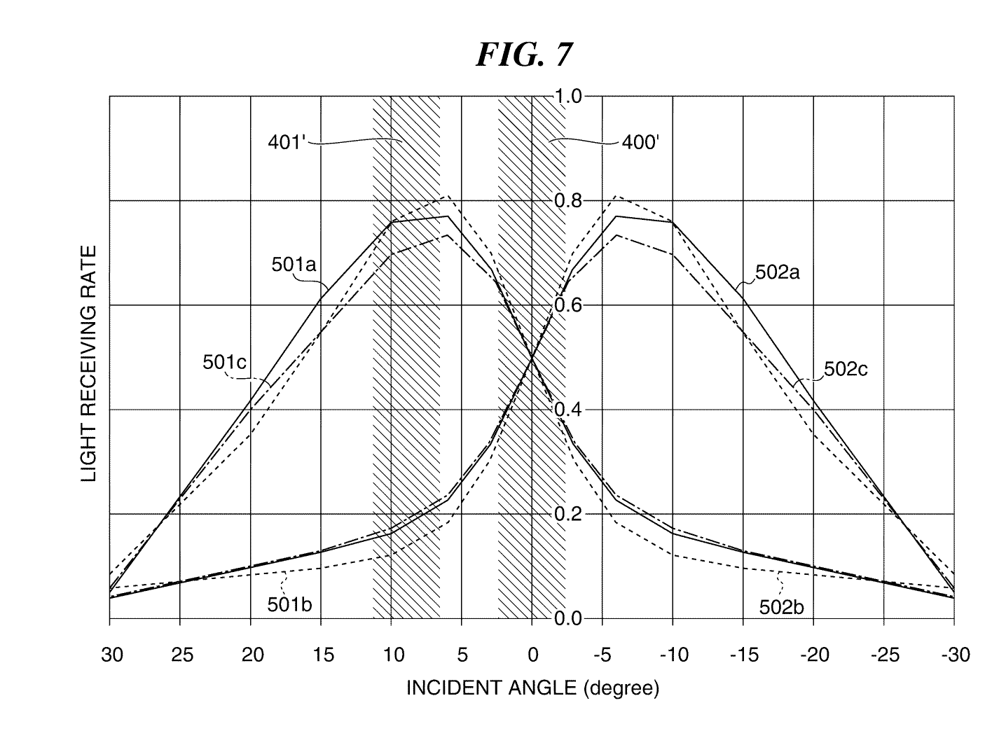

FIG. 7 is a view showing exemplary pupil intensity distributions of the image pickup device according to the present embodiment and the comparative examples 1 and 2.

In FIG. 7, the horizontal axis represents the incident angle of light with respect to an optical axis, and the vertical axis represents light receiving rate. A pupil intensity distribution 501a (502a) in the sub pixel 201 (202) of the image pickup device 107 according to the present embodiment is indicated by a solid line, and a pupil intensity distribution 501b (502b) in the sub pixel 201 (202) of the comparative example 1 is indicated by a broken line. A pupil intensity distribution 501c (502c) in the sub pixel 201 (202) of the comparative example 2 is indicated by an alternate long and short dash line.

Further, in FIG. 7, an incident angle range 400′ in which no pupil shift occurs at a peripheral image height corresponds to the exit pupil 400 of the imaging optical system at a peripheral image height in a case where the exit pupil distance Dl of the imaging optical system appearing in FIG. 6A and the setting pupil distance Ds of the image pickup device are the same. An incident angle range 401′ in which pupil shift occurs at a peripheral image height corresponds to the exit pupil 401 of the imaging optical system at a peripheral image height in a case where the exit pupil distance Dl of the imaging optical system appearing in FIG. 6B is shorter than the setting pupil distance Ds of the image pickup device.

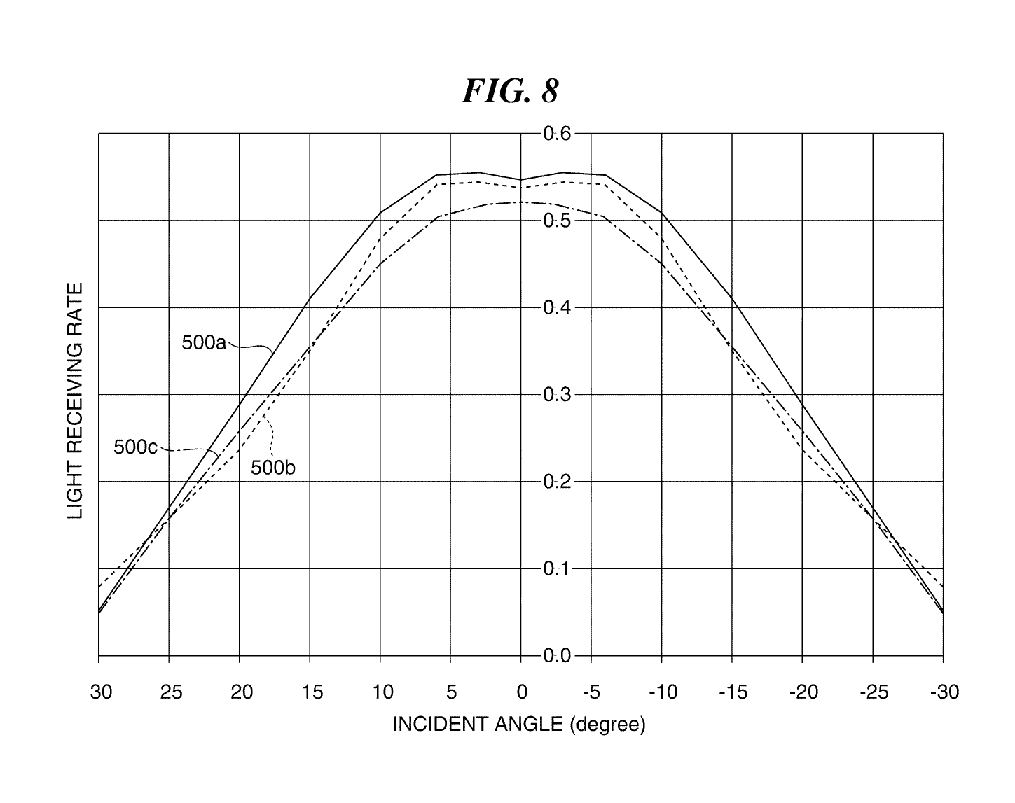

FIG. 8 is a view showing other exemplary pupil intensity distributions of the image pickup device according to the embodiment of the present invention and the comparative examples 1 and 2.

In FIG. 8, there are shown pupil intensity distributions in the above described pixel 200 which is a combination of the sub pixel 201 and the sub pixel 202. In FIG. 8, the horizontal axis represents the incident angle of light with respect to the optical axis, and the vertical axis represents light receiving rate. A pupil intensity distribution 500a in the pixel 200 of the image pickup device 107 according to the present embodiment is indicated by a solid line, and a pupil intensity distribution 500b in the pixel 200 of the comparative example 1 is indicated by a broken line. A pupil intensity distribution 500c in the pixel 200 of the comparative example 2 is indicated by an alternate long and short dash line.

Referring to FIG. 7, in an incident angle range 401 in which pupil shift occurs at a peripheral image height, a difference in light receiving rate between the pupil intensity distributions 501c and 502c of the sub pixel in the comparative example 2 is smaller than a difference in light receiving rate between the pupil intensity distributions 501b and 502b of the sub pixel in the comparative example 1. Therefore, in the comparative example 2, unevenness in the intensities of the A image and the B image can be reduced to a greater degree, and the capability to respond to pupil shift, which is associated with focus detection performance, is higher as compared to the comparative example 1.

On the other hand, as shown in FIG. 8, the maximum value of the light receiving rate in the pupil intensity distribution 500b of the pixel in the comparative example 1 is greater than the maximum value of the light receiving rate in the pupil intensity distribution 500c of the pixel in the comparative example 2. Therefore, conversely to the capability to respond to pupil shift, image pickup sensitivity associated with image pickup performance is higher in the comparative example 1 than in the comparative example 2.

As can be easily understood from the above description, the microlens curvature that realizes a high capability to respond to pupil shift associated with focus detection performance of the light-incident surface phase difference method is different from the microlens curvature that realizes satisfactory image pickup sensitivity associated with image pickup performances.

In the present embodiment, in the direction in which the number of division of the photoelectric converters is greater, the focal position of the microlens is shifted to a front focus side (the light receiving side) relative to the light receiving surfaces of the photoelectric converters. On the other hand, in the direction in which the number of division of the photoelectric converters is smaller, the focal position of the microlens is close to the light receiving surfaces of the photoelectric converters.

As a result, as shown in FIG. 7, in the incident angle range 401 in which pupil shift occurs at a peripheral image height, a difference in light receiving rate between the pupil intensity distributions 501a and 502a of the sub pixel according to the present embodiment can be made equal to a difference in light receiving rate between the pupil intensity distributions 501c and 502c of the sub pixel in the comparative example 2.

Further, as shown in FIG. 8, the maximum value of the light receiving rate in the pupil intensity distribution 500a of the pixel in the image pickup device 107 according to the present embodiment can be made equal to the maximum value of the light receiving rate in the pupil intensity distribution 500b of the pixel in the comparative example 2.

As a result, by using the image pickup device 107 according to the present embodiment, the capability to respond to pupil shift, which is associated with focal detection performance using the light-incident surface phase difference method, and image pickup sensitivity associated with image pickup performance can be made compatible with each other.

It should be noted that when the shape of a microlens is changed from a spherical shape as in the comparative example 1 and the comparative example 2 to a spheroidal shape as in the present embodiment, it is preferred that the aperture ratio of the microlens is increased by reducing the diagonal gap so that image pickup sensitivity can be improved. This the reason why, in FIG. 8, the maximum value of the light receiving rate in the pupil intensity distribution 500a is slightly greater than the maximum value of the light receiving rate in the pupil intensity distribution 500b of the comparative example 1.

As described above, according to the present embodiment, because the second division number for the photoelectric converters is set to be equal to or greater than the first division number, and the second curvature of the microlens divided in the second direction by the second division number is set to be greater than the first curvature of the microlens divided in the first direction by the first division number, the capability to respond to pupil shift, which is associated with focal detection performance using the light-incident surface phase difference method, and image pickup sensitivity associated with image pickup performance can be made compatible with each other.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-199363 filed Sep. 11, 2012, which is hereby incorporated by reference herein in its entirety.

What is claimed is:

1. An image pickup apparatus comprising:
an imaging optical system;
a plurality of image pickup pixels configured to detect a subject image formed by said imaging optical system and generate an image for image pickup; and
lenses configured to be disposed for respective ones of said plurality of image pickup pixels and gather incident light to the respective ones of said plurality of image pickup pixels,
wherein each of said plurality of image pickup pixels comprises a plurality of photoelectric converters that are divided in a first direction and a second direction perpendicular to the first direction,
each of the plurality of photoelectric converters photoelectrically converts each of a plurality of subject images having passed through pupil partial areas corresponding to respective ones of the plurality of photoelectric converters in an exit pupil of said imaging optical system and outputs focus detection signals for use in detecting a phase difference between the plurality of subject images, and
a first curvature of the lenses in the first direction and a second curvature of the lenses in the second direction are different.

2. An image pickup apparatus comprising:
an imaging optical system;
a plurality of image pickup pixels configured to detect a subject image formed by said imaging optical system and generate an image for image pickup; and
lenses configured to be disposed for respective ones of said plurality of image pickup pixels and gather incident light to the respective ones of said plurality of image pickup pixels,
wherein each of said plurality of image pickup pixels comprises a plurality of photoelectric converters that are divided in a first direction and a second direction perpendicular to the first direction,
each of the plurality of photoelectric converters photoelectrically converts each of a plurality of subject images having passed through pupil partial areas corresponding to respective ones of the plurality of photoelectric converters in an exit pupil of said imaging optical system and outputs focus detection signals for use in detecting a phase difference between the plurality of subject images, and
a focal position of the lenses in the first direction and a focal position of the lenses in the second direction are different.

3. An image pickup apparatus comprising:
an imaging optical system;
a plurality of image pickup pixels configured to detect a subject image formed by said imaging optical system and generate an image for image pickup; and
lenses configured to be disposed for respective ones of said plurality of image pickup pixels and gather incident light to the respective ones of said plurality of image pickup pixels,
wherein each of said plurality of image pickup pixels comprises a plurality of photoelectric converters that are divided in a first direction and a second direction perpendicular to the first direction,
each of the plurality of photoelectric converters photoelectrically converts each of a plurality of subject images having passed through pupil partial areas corresponding to respective ones of the plurality of photoelectric converters in an exit pupil of said imaging optical system and outputs focus detection signals for use in detecting a phase difference between the plurality of subject images, and
a first curvature of the lenses in the first direction is greater than a second curvature of the lenses in the second direction.

4. The image pickup apparatus according to claim 3, wherein the plurality of photoelectric converters are divided in the first direction by a first division number and in the second direction by a second division number, and
the first division number is equal to or greater than the second division number.

5. An image pickup apparatus comprising:
an imaging optical system;
a plurality of image pickup pixels configured to detect a subject image formed by said imaging optical system and generate an image for image pickup; and
lenses configured to be disposed for respective ones of said plurality of image pickup pixels and gather incident light to the respective ones of said plurality of image pickup pixels,
wherein each of said plurality of image pickup pixels comprises a plurality of photoelectric converters that are divided in a first direction and a second direction perpendicular to the first direction,
each of the plurality of photoelectric converters photoelectrically converts each of a plurality of subject images having passed through pupil partial areas corresponding to respective ones of the plurality of photoelectric converters in an exit pupil of said imaging optical system and outputs focus detection signals for use in detecting a phase difference between the plurality of subject images, and
a focal position of the lenses in the first direction lies on a subject side relative to light-receiving surfaces of the plurality of photoelectric converters, and a focal position of the lenses in the second direction lies on the light-receiving surfaces of the plurality of photoelectric converters.

6. The image pickup apparatus according to claim 5, wherein the plurality of photoelectric converters are divided in the first direction by a first division number and in the second direction by a second division number, and
the first division number is equal to or greater than the second division number.

7. A control method for an image pickup apparatus which has an imaging optical system, a plurality of image pickup pixels that detect a subject image formed by the imaging optical system and generate an image for image pickup, each of the plurality of image pickup pixels having a plurality of photoelectric converters divided in a first direction and a second direction perpendicular to the first direction, and lenses that are disposed for respective ones of the plurality of image pickup pixels and gather incident light to the respective ones of the plurality of image pickup pixels, comprising:
a setting step of making a first curvature of the lenses in the first direction and a second curvature of the lenses in the second direction different from each other;
a photoelectrical conversion step of photoelectrically converting a plurality of subject images having passed through pupil partial areas corresponding to respective ones of the plurality of photoelectric converters in an exit pupil of the imaging optical system;
an output step of outputting focus detection signals based on the plurality of subject images that have been photoelectrically converted; and
a phase difference detection step of detecting a phase difference between the plurality of subject images based on the output focus detection signals.
